(19) United States
(12) Patent Application Publication
(10) Pub. No.: US 2026/0010116 A1
(43) Pub. Date: Jan. 8, 2026

(54) IMAGE-FORMING APPARATUS INCLUDING OPERATING MEMBER DISPOSED ON MOVABLE COVER FOR OPENING AND CLOSING SHUTTER OF TONER CONTAINER

(71) Applicant: BROTHER KOGYO KABUSHIKI KAISHA, Nagoya (JP)

(72) Inventors: Shougo SATO, Seto (JP); Masahiko HAYAKAWA, Ama (JP)

(73) Assignee: BROTHER KOGYO KABUSHIKI KAISHA, Nagoya (JP)

(21) Appl. No.: 19/229,156

(22) Filed: Jun. 5, 2025

(30) Foreign Application Priority Data
Jul. 5, 2024 (JP) 2024-109263

(51) Int. Cl. G03G 21/18; G03G 21/16

(52) U.S. Cl. CPC G03G 21/1832; G03G 21/1633; G03G 21/1814

(57) ABSTRACT

An image-forming apparatus includes: a main housing having a first opening; a process cartridge mountable in and removable from the main housing through the first opening; and a first cover movable relative to the main housing to open and close the first opening. The process cartridge includes a drum unit including a photosensitive drum; a developing unit including a developing roller; and a receptacle to which a toner container is connectable. The first cover has a second opening through which the receptacle can be exposed. The toner container includes: a discharging part connectable to the receptacle; and a container-side shutter disposed on the discharging part for opening and closing the discharging part. The first cover includes an operating member configured to move the container-side shutter of the toner container to open and close the discharging part while the toner container is connected to the receptacle.

### REFERENCE TO RELATED APPLICATIONS

This application claims priority from Japanese Patent Application No. 2024-109263 filed on Jul. 5, 2024. The entire content of the priority application is incorporated herein by reference.

### BACKGROUND ART

There has been known an image-forming apparatus configured with a developing unit that can be replenished with toner from a toner pack. The toner pack storing the toner is mounted into a supply port of the developing unit and rotated 180 degrees to open a shutter member of the toner pack, thereby allowing the toner in the toner pack to be supplied into the developing unit.

If the toner pack used in the above-described image-forming apparatus is formed of a resin bag that is easily deformable, the toner pack may change its shape as the bag is rotated, which may worsen the operability of the toner pack. One possible method of resolving this issue is to provide an operating member on a part of the developing unit around the supply port for rotating the shutter member of the toner pack.

### SUMMARY

However, in a case where the operating member is disposed on the developing unit, a user may have difficulty in manipulating the operating member if the operating member is disposed inside a main housing of the image-forming apparatus at a position far away from the side on which a user operates the operating member.

Further, in a case where the image-forming apparatus is configured such that a process cartridge including the developing unit can be detachably mounted in the main housing and an opening is formed in the main housing for mounting and removing the process cartridge, the operating member could interfere with the operations to mount and remove the process cartridge through the opening if the operating member is disposed on the main housing near the opening.

In view of the foregoing, it is an object of the present disclosure to provide an image-forming apparatus capable of facilitating the opening and closing of a shutter member on a toner container used for replenishing the developing unit of a process cartridge with toner while also facilitating the mounting and removal of the process cartridge relative to the main housing of the image-forming apparatus.

In order to attain the above and other objects, the present disclosure provides an image-forming apparatus including a main housing, a process cartridge, and a first cover. The main housing has a first opening. The process cartridge is mountable in and removable from the main housing through the first opening. The process cartridge includes a drum unit, a developing unit, and a receptacle. The drum unit includes a photosensitive drum. The developing unit includes a developing roller. To the receptacle, a toner container storing toner is connectable. The toner container includes: a discharging part connectable to the receptacle; and a container-side shutter disposed on the discharging part for opening and closing the discharging part. The first cover is movable relative to the main housing to open and close the first opening. The first cover has a second opening through which the receptacle can be exposed. The first cover includes an operating member configured to move the container-side shutter to open and close the discharging part in a state where the discharging part of the toner container is connected to the receptacle.

With this configuration, the container-side shutter of the toner container connected to the receptacle can be easily opened and closed by the operating member. Further, since the operating member is disposed on the first cover and moves together with the first cover as the first cover is opened and closed, the operating member does not interfere with the operations for mounting and removing the process cartridge in and from the main housing of the image-forming apparatus through the first opening. Hence, this configuration can facilitate the mounting and removal of the process cartridge relative to the main housing.

### BRIEF DESCRIPTION OF DRAWINGS

FIG. 1 is a central cross-sectional view of an image-forming apparatus.

FIG. 2 is a perspective view of the image-forming apparatus in a state where a front cover is in a first closed position thereof and a refill cover is in a second closed position thereof.

FIG. 3 is a cross-sectional side view illustrating a state where the front cover is in a first open position and a process cartridge is removed from a main housing through an opening.

FIG. 4 is a cross-sectional side view of the process cartridge that has been mounted in the main housing.

FIG. 5 is a side view of the process cartridge.

FIG. 6 is a plan view of the process cartridge.

FIG. 7 is a perspective view of the process cartridge.

FIG. 8 is a perspective view of a drum unit of the process cartridge.

FIG. 9 is a perspective view of a developing unit of the process cartridge.

FIG. 10 is a cross-sectional side view of an operating member in a first position thereof and a unit-side shutter in a first shutter closed position thereof.

FIG. 11 is a side cross-sectional view of the operating member in a second position thereof and the unit-side shutter in a first shutter open position thereof.

FIG. 12A is a plan view of the unit-side shutter in the first shutter closed position.

FIG. 12B is a plan view of the unit-side shutter in the first shutter open position.

FIG. 13 is a perspective view of the image-forming apparatus in a state where the front cover is in the first closed position and the refill cover is in a second open position thereof.

FIG. 14A is a cross-sectional side view of a toner container in a state where a container-side shutter is in a second shutter closed position thereof.

FIG. 14B is a bottom view of the toner container with the container-side shutter in the second shutter closed position.

FIG. 15A is a cross-sectional side view of the toner container in a state where the container-side shutter is in a second shutter open position thereof.

FIG. 15B is a bottom view of the toner container with the container-side shutter in the second shutter open position.

FIG. 16 is a partially-enlarged cross-sectional side view of the image-forming apparatus in a state where a discharging part of the toner container is connected to a receptacle of the process cartridge and the operating member is in the first position.

FIG. 17 is a partially-enlarged cross-sectional side view of the image-forming apparatus in a state where the discharging part of the toner container is connected to the receptacle of the process cartridge and the operating member is in the second position.

### DESCRIPTION

Hereinafter, an embodiment of the present disclosure will be described while referring to the accompanying drawings.

### Image-Forming Apparatus

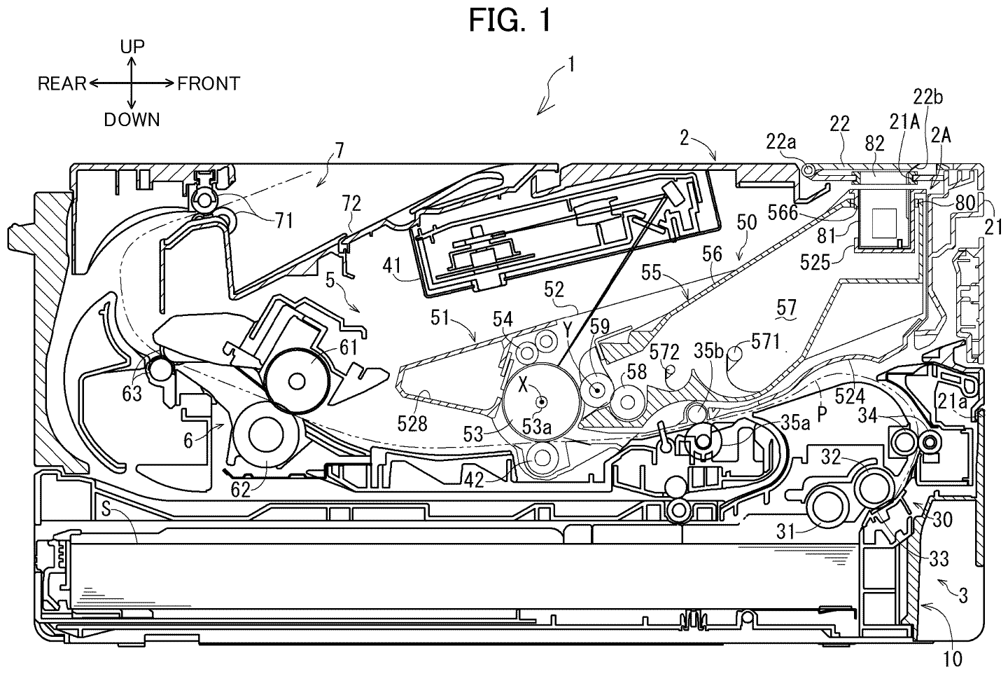

An image-forming apparatus 1 illustrated in FIG. 1 is an image-forming apparatus according to one embodiment of the present disclosure. Specifically, the image-forming apparatus 1 is a laser printer configured to form images on sheets S according to the electrophotographic method.

In the following description, the right side in FIG. 1 is defined as the front side of the image-forming apparatus 1, the left side in FIG. 1 is defined as the rear side of the image-forming apparatus 1, the near side in FIG. 1 is defined as the left side of the image-forming apparatus 1, and the far side in FIG. 1 is defined as the right side of the image-forming apparatus 1. Further, the top and bottom sides in FIG. 1 are defined as the top and bottom of the image-forming apparatus 1, respectively.

The image-forming apparatus 1 includes a main housing 2, a sheet-feeding unit 3, an image-forming unit 5, a fixing device 6, and a discharge unit 7. The main housing 2 accommodates the sheet-feeding unit 3, image-forming unit 5, fixing device 6, and discharge unit 7. The main housing 2 is an example of “main housing” of the disclosure.

As illustrated in FIGS. 1 through 3, an opening 2A is formed in a front end portion of the main housing 2. The main housing 2 includes a front cover 21 that can open and close the opening 2A. The opening 2A is an example of “first opening” of the disclosure, and the front cover 21 is an example of “first cover” of the disclosure.

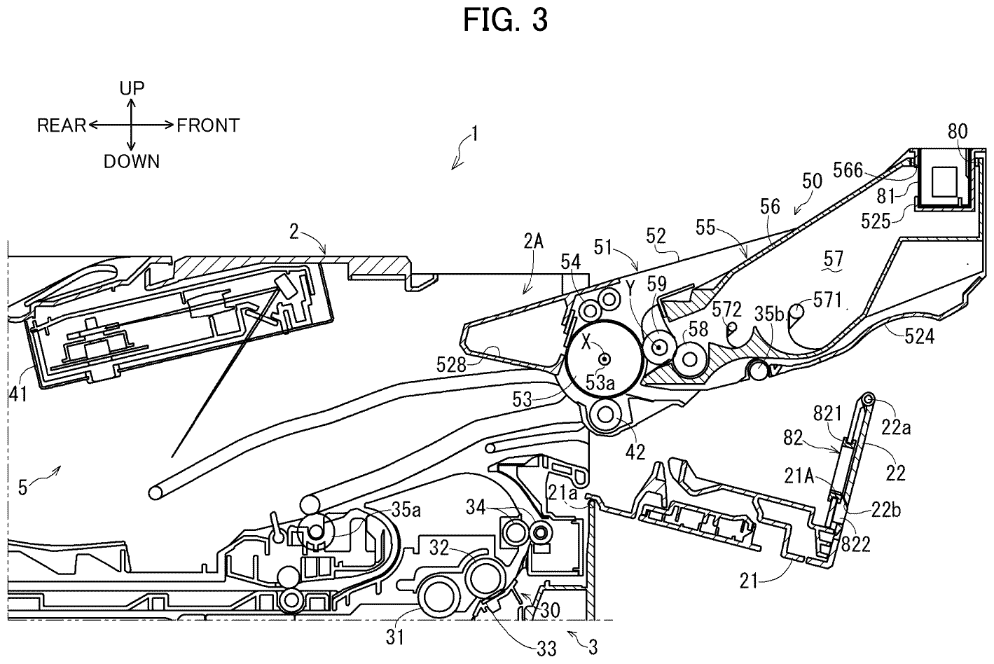

The front cover 21 is pivotable about an axis of a pivot shaft 21a disposed at a bottom end of the front cover 21. The pivot shaft 21a extends in a left-right direction. By pivoting about the axis of the pivot shaft 21a, the front cover 21 is movable between a first closed position (illustrated in FIG. 1) for covering the opening 2A and a first open position (illustrated in FIG. 3) for exposing the opening 2A. The front cover 21 is positioned farther forward at the first open position than at the first closed position. That is, the front cover 21 is positioned farther away from the front end portion of the main housing 2 in the front-rear direction at the first open position than at the first closed position. The front end portion of the main housing 2 is an example of “first end portion” of the main housing of the disclosure.

The sheet-feeding unit 3 includes a sheet tray 10 configured to support the sheets S, a sheet conveying unit 30, a conveying roller pair 34, and a registration roller 35a. The sheet-feeding unit 3 is arranged in a bottom section of the main housing 2. The sheet-feeding unit 3 is configured to convey the sheets S supported on the sheet tray 10 to the image-forming unit 5. The image-forming apparatus 1 has a conveying path P for conveying the sheets S from the sheet-feeding unit 3 to the discharge unit 7 through the image-forming unit 5.

The sheet conveying unit 30 is a conveying mechanism that functions to pick up the sheets S accommodated in the sheet tray 10, separate the sheets S one by one, and convey each separated sheet S toward the image-forming unit 5. The sheet conveying unit 30 includes a feed roller 31, a separating roller 32, and a separating pad 33.

The feed roller 31 is configured to feed the sheets S supported on the sheet tray 10 toward the separating roller 32. The separating roller 32 is arranged downstream of the feed roller 31 in a sheet conveying direction. The separating pad 33 is arranged to face the separating roller 32 and is urged toward the separating roller 32.

The sheets S fed toward the separating roller 32 by the feed roller 31 are separated one by one between the separating roller 32 and the separating pad 33. The separated sheets S are then conveyed onto the conveying path P one by one.

The sheets S fed onto the conveying path P are then conveyed to the image-forming unit 5 by the conveying roller pair 34, the registration roller 35a, and a pinch roller 35b arranged to face the registration roller 35a. The registration roller 35a is configured to first halt movement of each sheet S by contacting a leading edge of the conveyed sheet S and then convey the sheet S toward the image-forming unit 5 at a prescribed timing.

The image-forming unit 5 is disposed downstream of the sheet-feeding unit 3 in the sheet conveying direction. The image-forming unit 5 is configured to form images on the sheets S conveyed from the sheet-feeding unit 3. The image-forming unit 5 includes a process cartridge 50 configured to transfer an image onto a surface of each sheet S conveyed from the sheet-feeding unit 3, and an exposure unit 41 configured to expose a surface of a photosensitive drum 53 disposed in the process cartridge 50. The process cartridge 50 is an example of “process cartridge” of the disclosure.

The process cartridge 50 is detachably mountable in the main housing 2. The process cartridge 50 includes a drum unit 51, and a developing unit 55. The process cartridge 50 is mounted in the main housing 2 with the developing unit 55 attached to the drum unit 51. When mounted in the main housing 2, the process cartridge 50 is positioned above the sheet-feeding unit 3. The developing unit 55 is not detachable relative to the drum unit 51.

The drum unit 51 includes the photosensitive drum 53, a charging roller 54, and a transfer roller 42. The developing unit 55 has a toner chamber 57, a supply roller 58, and a developing roller 59. The drum unit 51 supports the pinch roller 35b.

As illustrated in FIG. 3, the opening 2A of the main housing 2 allows passage of the process cartridge 50. Therefore, by moving the front cover 21 into the first open position, the process cartridge 50 can easily be mounted in and removed from the main housing 2 through the opening 2A. The process cartridge 50 mounted in the main housing 2 is to be removed from the main housing 2 when the process cartridge 50 needs to be replaced or when a sheet S causes a paper jam near the photosensitive drum 53 and the transfer roller 42, for example.

The process cartridge 50 is configured to be mounted in the main housing 2 by inserting the drum unit 51 and the developing unit 55 attached to the drum unit 51 together into the main housing 2. The process cartridge 50 is configured to be removed from the main housing 2 by pulling the drum unit 51 and the developing unit 55 attached to the drum unit 51 from the main housing 2 as a unit.

In a state where the process cartridge 50 is mounted in the main housing 2, the photosensitive drum 53 is arranged in such an orientation that a rotational axis X thereof is aligned in the left-right direction. The photosensitive drum 53 has a metal drum shaft 53a extending along the rotational axis X. The photosensitive drum 53 is rotatable about the rotational axis X.

In the state where the process cartridge 50 is mounted in the main housing 2, the developing roller 59 is arranged in such an orientation that a rotational axis Y thereof is aligned in the left-right direction. The developing roller 59 is rotatable about the rotational axis Y. The rotational axis Y of the developing roller 59 is parallel to the rotational axis X of the photosensitive drum 53.

Incidentally, the process cartridge 50 according to the present embodiment includes the drum unit 51 having the photosensitive drum 53 and the developing unit 55 attached to the drum unit 51 and having the developing roller 59. Alternatively, the process cartridge 50 may be configured of: a cartridge having the photosensitive drum 53 and developing roller 59; and a toner box storing toner and attached to the cartridge.

Still alternatively, the drum unit 51 possessing the photosensitive drum 53 and the developing unit 55 possessing the developing roller 59 may be configured to be mounted separately in the main housing 2 of the image-forming apparatus 1.

The exposure unit 41 includes a laser diode, a polygon mirror, lenses, and reflecting mirrors. The exposure unit 41 is configured to expose the surface of the photosensitive drum 53 to light by emitting a laser light toward the photosensitive drum 53 based on image data inputted into the image-forming apparatus 1.

The toner chamber 57 is configured to store toner as a developer. The toner accommodated in the toner chamber 57 is configured to be supplied onto the supply roller 58 while being agitated by agitators 571 and 572. The supply roller 58 is configured to supply the toner received from the toner chamber 57 to the developing roller 59.

The developing roller 59 is arranged in close contact with the supply roller 58. The developing roller 59 is configured to carry the toner that has been supplied from the supply roller 58 and that has been positively charged by a sliding member (not illustrated). The developing roller 59 is configured to be applied with a developing bias by a bias applying means (not illustrated).

The photosensitive drum 53 is arranged adjacent to the developing roller 59. The surface of the photosensitive drum 53 is configured to be exposed to light by the exposure unit 41 after being uniformly charged by the charging roller 54. The exposed areas on the photosensitive drum 53 have a lower potential than other areas, enabling an electrostatic latent image to be formed on the photosensitive drum 53 based on image data. Subsequently, positively charged toner is supplied from the developing roller 59 onto the surface of the photosensitive drum 53 on which the electrostatic latent image was formed, thereby developing the electrostatic latent image into a visible toner image.

The transfer roller 42 is arranged to face the photosensitive drum 53. The transfer roller 42 is configured to be applied with a transfer bias by a bias applying means (not illustrated). As the transfer bias is applied to the surface of the transfer roller 42, a sheet S is conveyed while being nipped between the transfer roller 42 and the photosensitive drum 53 on which a toner image has been formed. At this time the toner image formed on the surface of the photosensitive drum 53 is transferred onto the surface of the sheet S. After the toner image has been transferred, the sheet S is conveyed to the fixing device 6.

The fixing device 6 includes a heating roller 61, and a pressure roller 62. The image transferred onto the sheet S by the process cartridge 50 is configured to be fixed to the sheet S in the fixing device 6. The heating roller 61 is configured to be heated upon receipt of power from a power source (not illustrated). The pressure roller 62 is arranged to face the heating roller 61. One of the heating roller 61 and pressure roller 62 is urged toward the other by an urging mechanism (not illustrated) so that the heating roller 61 and pressure roller 62 are in close contact with each other.

When a sheet S having a toner image transferred thereon is conveyed to the fixing device 6, the sheet S becomes nipped between the heating roller 61 and pressure roller 62. While the heating roller 61 and pressure roller 62 convey the sheet S with the sheet S nipped therebetween, the heating roller 61 heats the sheet S to thermally fix the toner image thereon. In this way, the toner image is fixed to the sheet S in the fixing device 6.

The fixing device 6 includes a post-fixing conveying roller pair 63 configured to convey the sheet S to the discharge unit 7 after the toner image is fixed to the sheet S by the fixing device 6.

The discharge unit 7 is located downstream of the fixing device 6 in the sheet conveying direction. The discharge unit 7 is configured to discharge each sheet S outside of the image-forming apparatus 1 after an image is formed on the sheet S at the image-forming unit 5. The discharge unit 7 includes a discharge roller pair 71, and a discharge tray 72. The discharge roller pair 71 is configured to discharge each sheet S conveyed from the fixing device 6 along the conveying path P toward the outside of the main housing 2. The discharge tray 72 is formed on a top surface of the main housing 2. The discharge tray 72 is configured to support each sheet S discharged out of the main housing 2 by the discharge roller pair 71.

### Process Cartridge

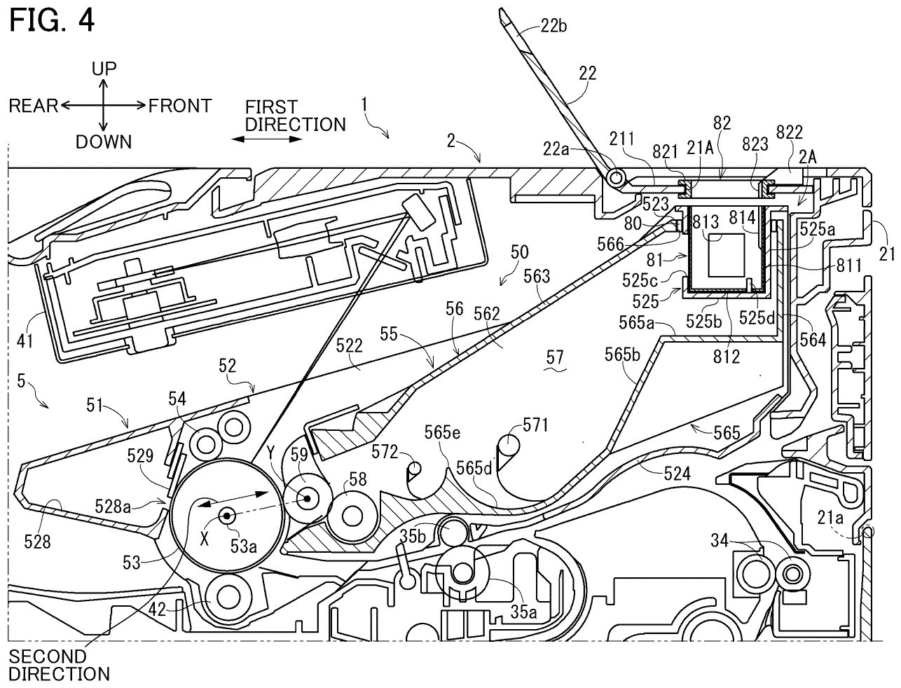

As illustrated in FIG. 4, the process cartridge 50 is detachably mounted in the main housing 2. When mounted in the main housing 2, the process cartridge 50 is accommodated inside the main housing 2. As described above, the process cartridge 50 includes the drum unit 51 and the developing unit 55. That is, the drum unit 51 and developing unit 55 constitute the process cartridge 50.

In the state where the process cartridge 50 is mounted in the main housing 2, the drum unit 51 is fixed in position relative to the main housing 2 and the developing unit 55 is movable relative to the drum unit 51.

### Drum Unit

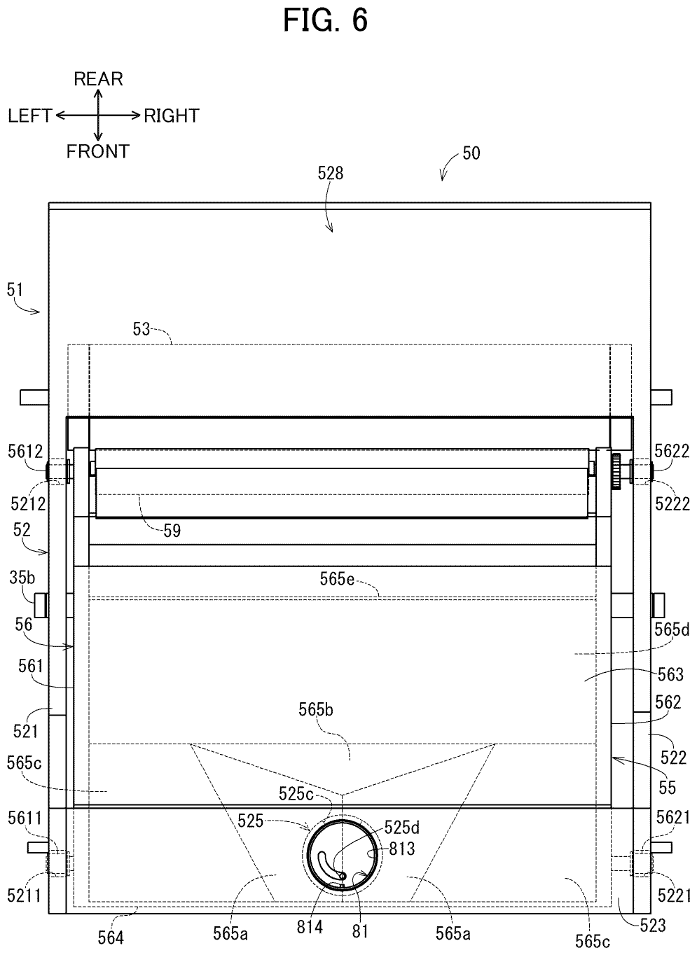

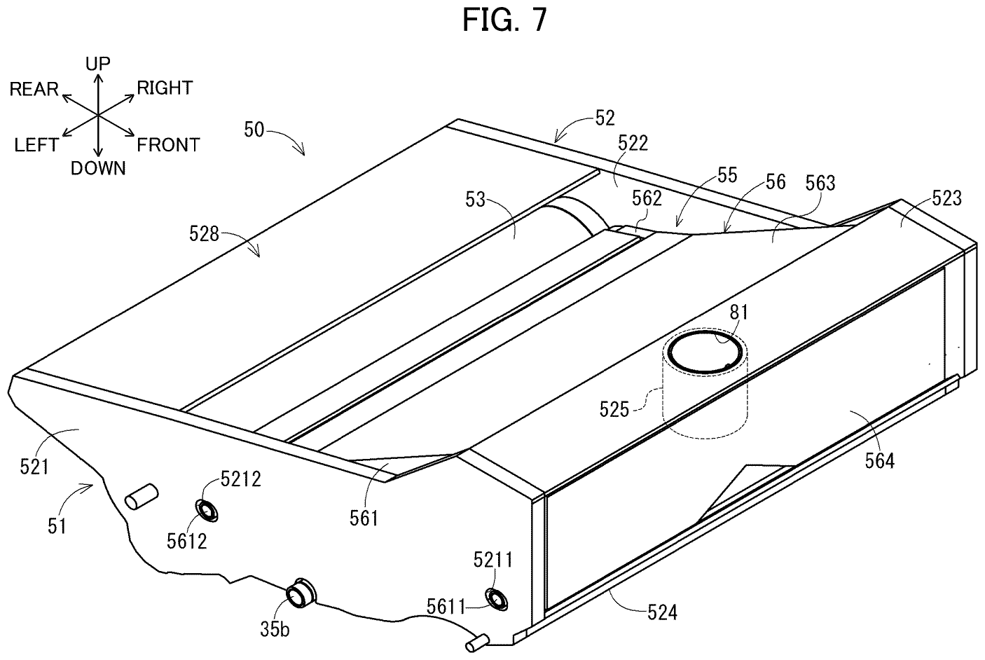

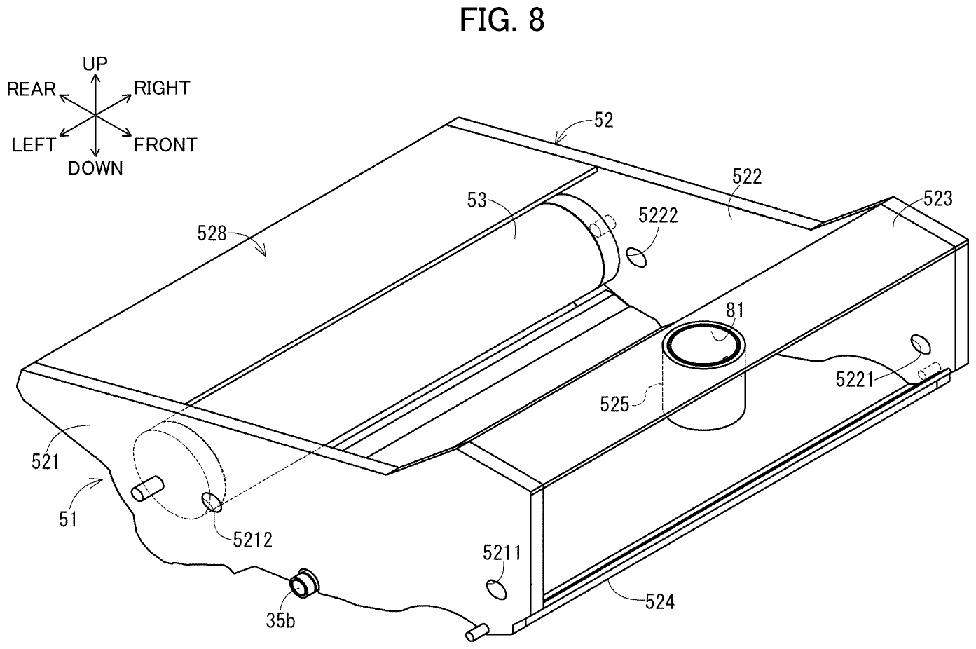

As illustrated in FIGS. 4 through 8, the drum unit 51 further includes a drum frame 52, in addition to the above-described photosensitive drum 53, charging roller 54, and transfer roller 42. The drum frame 52 supports the photosensitive drum 53, charging roller 54, and transfer roller 42. The photosensitive drum 53, charging roller 54, and transfer roller 42 are arranged at a rear end portion of the drum unit 51 in a front-rear direction.

The drum frame 52 includes a left side plate 521, a right side plate 522, a top plate 523, a bottom plate 524, a receptacle 525, a waste toner container 528, and a blade 529.

The left side plate 521 constitutes a left end portion of the drum frame 52, and the right side plate 522 constitutes a right end portion of the drum frame 52. The left side plate 521 and right side plate 522 each extend in both the front-rear direction and an up-down direction. The left side plate 521 and right side plate 522 oppose each other in the left-right direction. The photosensitive drum 53, charging roller 54, and transfer roller 42 are positioned between the left side plate 521 and right side plate 522.

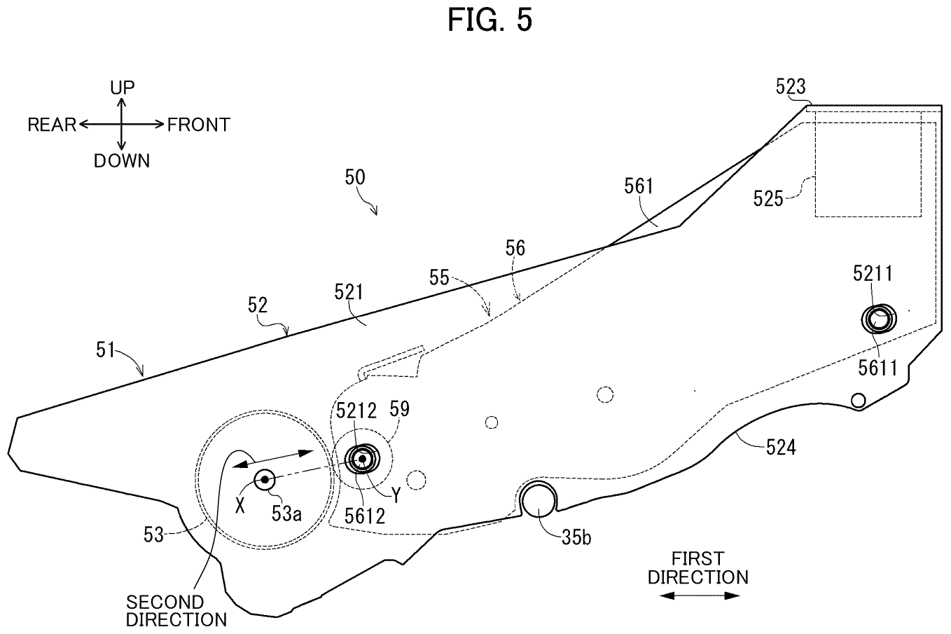

The left side plate 521 has a first elongate hole 5211 and a second elongate hole 5212 each extending through the left side plate 521 in the left-right direction. Each of the first elongate hole 5211 and second elongate hole 5212 is an elongated through-hole whose long axis is aligned in a second direction. The second direction is a direction of a line connecting the rotational axis X of the photosensitive drum 53 to the rotational axis Y of the developing roller 59 (see FIGS. 4 and 5). The second direction is sloped relative to the front-rear direction, and also crosses the rotational axis X of the photosensitive drum 53. The first elongate hole 5211 is positioned in a front end portion of the left side plate 521, and the second elongate hole 5212 is positioned rearward of the first elongate hole 5211.

The right side plate 522 has a first elongate hole 5221 and a second elongate hole 5222 each extending through the right side plate 522 in the left-right direction. Each of the first elongate hole 5221 and second elongate hole 5222 is an elongated through-hole whose long axis is oriented in the second direction. The first elongate hole 5221 is positioned in a front end portion of the right side plate 522, and the second elongate hole 5222 is positioned rearward of the first elongate hole 5221.

The top plate 523 constitutes a top-front end portion of the drum frame 52. The top plate 523 extends in both the left-right direction and front-rear direction. The top plate 523 connects the left side plate 521 and the right side plate 522 to each other. The bottom plate 524 constitutes a bottom end portion of the drum frame 52. The bottom plate 524 extends in both the left-right direction and front-rear direction. The bottom plate 524 connects the left side plate 521 and right side plate 522 to each other.

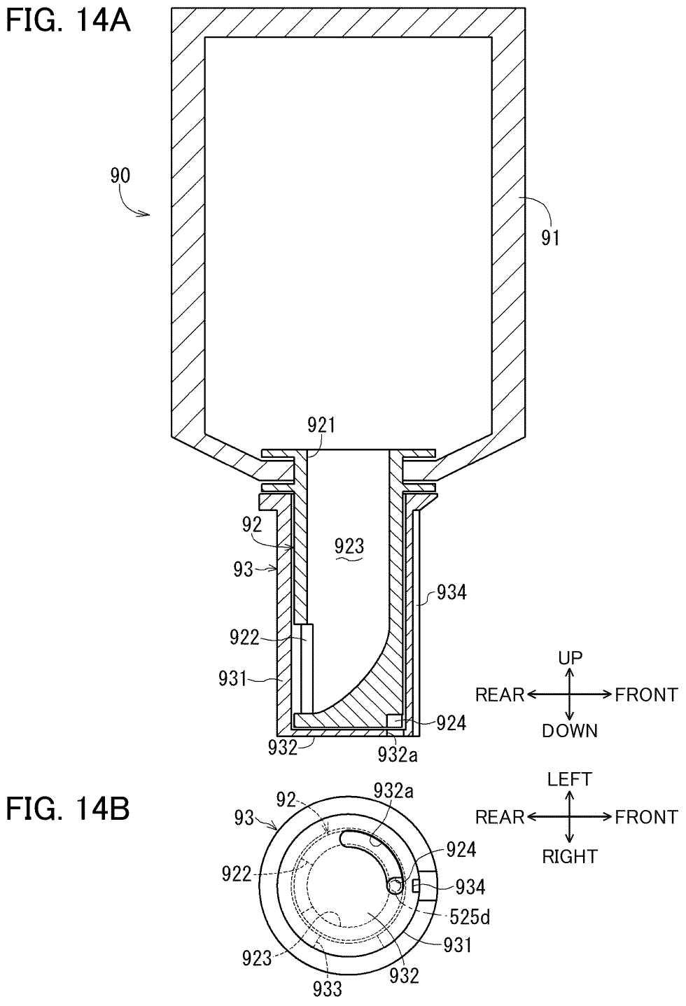

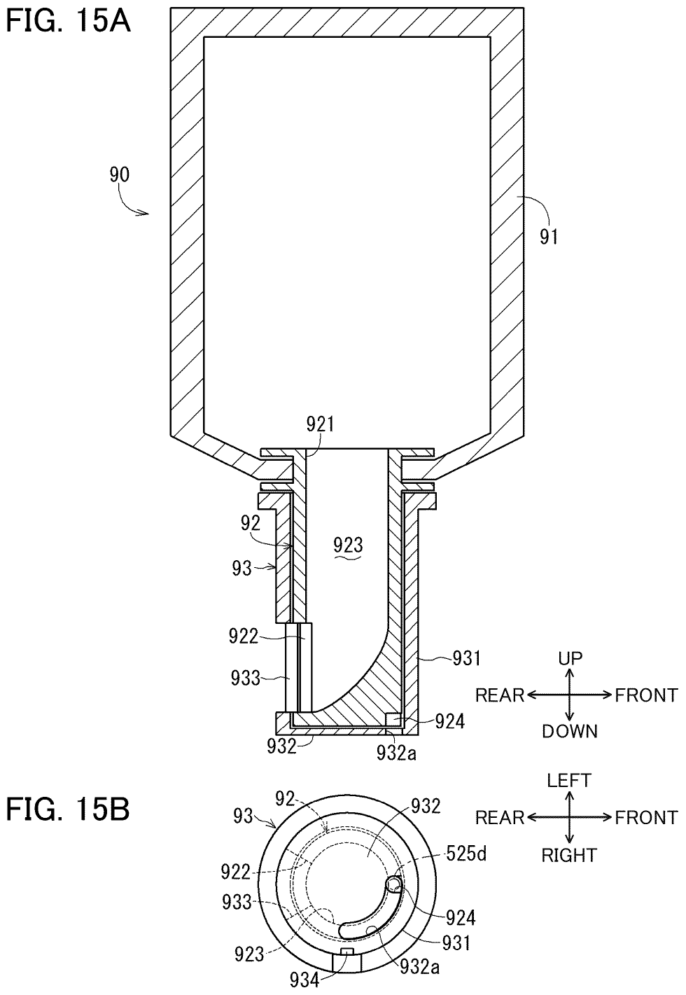

The receptacle 525 is a part to which a toner container 90 (see FIGS. 14 and 15) is to be connected for supplying toner to the process cartridge 50. The receptacle 525 has a cylindrical portion 525a, a bottom portion 525b, a supply port 525c, and an anchoring pin 525d.

The cylindrical portion 525a is in a form of a hollow cylindrical shape that extends downward from the top plate 523. The cylindrical portion 525a has a top end that is open in a left-right center region of the top plate 523. The bottom portion 525b is a plate-shaped member that closes a bottom end of the cylindrical portion 525a. The supply port 525c is open in a rear end of the cylindrical portion 525a and provides communication between the receptacle 525 and the toner chamber 57 in the front-rear direction. The anchoring pin 525d protrudes upward from a top surface of the bottom portion 525b. The anchoring pin 525d is an example of “third engaging part” of the disclosure.

The receptacle 525 is arranged at a front end portion of the drum unit 51. In the state where the process cartridge 50 is mounted in the main housing 2, the receptacle 525 is positioned in the front end portion of the main housing 2. The front-rear direction is an example of “first direction” of the disclosure.

The waste toner container 528 is positioned at a rear end portion of the drum unit 51. The waste toner container 528 is positioned rearward of the photosensitive drum 53. The waste toner container 528 has an opening 528a that is arranged to oppose the photosensitive drum 53. The waste toner container 528 can accommodate waste toner therein.

The blade 529 is a plate-shaped member extending in the left-right direction. The blade 529 is in contact with the surface of the photosensitive drum 53. The blade 529 is mounted over a periphery of the opening 528a on the waste toner container 528. As the photosensitive drum 53 rotates, waste toner deposited on the surface of the photosensitive drum 53 is scraped off the photosensitive drum 53 by the blade 529 and falls through the opening 528a to be collected in the waste toner container 528.

### Developing Unit

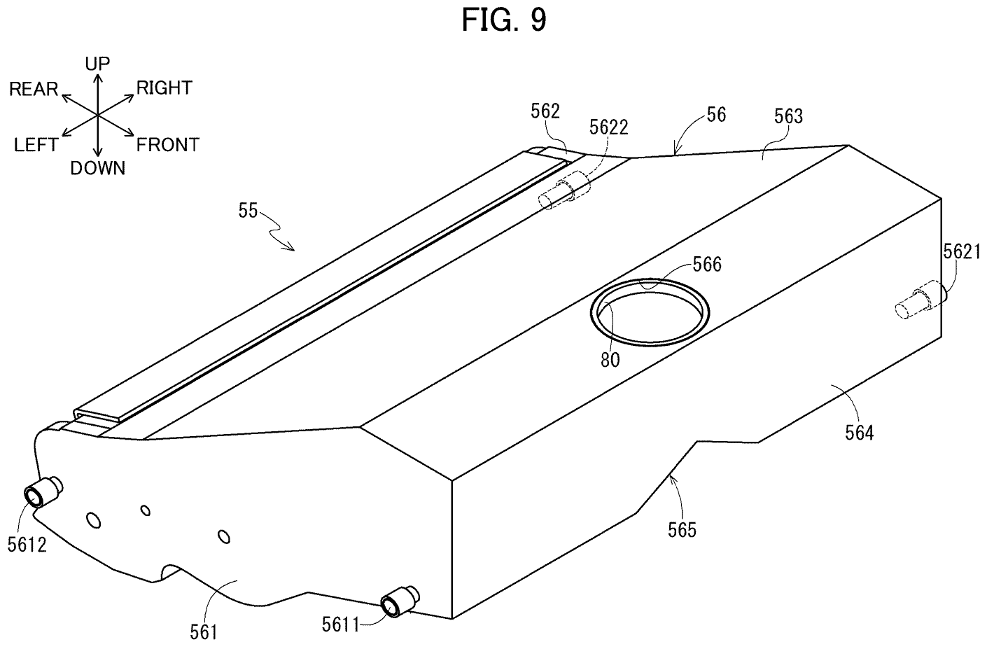

As illustrated in FIGS. 4 through 7 and 9, the developing unit 55 further includes a developing unit frame 56, in addition to the supply roller 58 and developing roller 59. The developing unit frame 56 supports the supply roller 58 and developing roller 59. The supply roller 58 and developing roller 59 are disposed in a rear end portion of the developing unit 55. The toner chamber 57 is formed in an interior of the developing unit frame 56.

The developing unit frame 56 is positioned inside a space defined by the left side plate 521, right side plate 522, top plate 523, and bottom plate 524 of the drum frame 52. The developing unit frame 56 has a left side wall 561, a right side wall 562, a top wall 563, a front wall 564, a bottom wall 565, and an insertion opening 566.

The left side wall 561 constitutes a left end portion of the developing unit frame 56, and the right side wall 562 constitutes a right end portion of the developing unit frame 56. The left side wall 561 and right side wall 562 each extend in both the front-rear direction and up-down direction, and oppose each other in the left-right direction. The supply roller 58 and developing roller 59 are positioned between the left side wall 561 and the right side wall 562.

The left side wall 561 has a first pin 5611 and a second pin 5612 each protruding leftward from a left surface of the left side wall 561. The first pin 5611 is positioned at a front end portion of the left side wall 561, and the second pin 5612 is positioned on a rear end portion of the left side wall 561. The second pin 5612 is positioned rearward of the first pin 5611. The second pin 5612 may be a left end of a rotational shaft of the developing roller 59.

The first pin 5611 and second pin 5612 are respectively fitted into the first elongate hole 5211 and second elongate hole 5212 formed in the left side plate 521 of the drum frame 52. The first pin 5611 and second pin 5612 are movable in directions along the long axes of the first elongate hole 5211 and second elongate hole 5212, respectively.

The right side wall 562 has a first pin 5621 and a second pin 5622 each protruding rightward from a right surface of the right side wall 562. The first pin 5621 is positioned on a front end portion of the right side wall 562, and the second pin 5622 is positioned on a rear end portion of the right side wall 562. The second pin 5622 is positioned rearward of the first pin 5621. The second pin 5622 may be a right end of the rotational shaft of the developing roller 59.

The first pin 5621 and second pin 5622 are respectively fitted into the first elongate hole 5221 and second elongate hole 5222 formed in the right side plate 522 of the drum frame 52. The first pin 5621 and second pin 5622 are movable in directions along the long axes of the first elongate hole 5221 and second elongate hole 5222, respectively.

With the first pin 5611 and second pin 5612 moving along the long axes of the first elongate hole 5211 and second elongate hole 5212 and the first pin 5621 and second pin 5622 moving along the long axes of the first elongate hole 5221 and second elongate hole 5222, the developing unit 55 can move in the second direction relative to the drum unit 51. Accordingly, the developing roller 59 is movable in the second direction relative to the photosensitive drum 53.

The top wall 563 constitutes a top end portion of the developing unit frame 56. The top wall 563 extends in both the left-right direction and front-rear direction and connects the left side wall 561 and the right side wall 562 to each other. The insertion opening 566 is formed in a left-right center region of the top wall 563 at a front end portion thereof. Thus, the insertion opening 566 is open at a front end portion of the developing unit 55. The insertion opening 566 is in communication with the toner chamber 57.

The receptacle 525 is inserted in the insertion opening 566 from above. The receptacle 525 of the drum unit 51 has entered an interior of the toner chamber 57 of the developing unit 55 through the insertion opening 566. The supply port 525c of the receptacle 525 is in communication with the toner chamber 57 in the front-rear direction. The front wall 564 extends downward from a front end of the top wall 563 and connects the left side wall 561 and the right side wall 562 to each other.

The bottom wall 565 constitutes a bottom end portion of the developing unit frame 56. The bottom wall 565 extends in both the left-right direction and front-rear direction and connects the left side wall 561 and right side wall 562 to each other. The bottom wall 565 has a pair of first bottom surfaces 565a, a second bottom surface 565b, a pair of third bottom surfaces 565c, a fourth bottom surface 565d, and a projecting wall 565e. The first bottom surfaces 565a, second bottom surface 565b, third bottom surfaces 565c, and fourth bottom surface 565d are surfaces of the bottom wall 565 facing upward and constitute in combination a bottom surface of the toner chamber 57.

The first bottom surfaces 565a are positioned below the insertion opening 566. The first bottom surfaces 565a extend respectively leftward and rightward from a position at which the insertion opening 566 is projected vertically onto the bottom surface of the toner chamber 57. The first bottom surfaces 565a are sloped surfaces that slope downward toward the left and right, respectively. Specifically, the first bottom surface 565a on the left slopes downward toward the left, while the first bottom surface 565a on the right slopes downward toward the right.

The first bottom surfaces 565a slope downward while extending away from the position at which the insertion opening 566 is projected vertically onto the bottom surface of the toner chamber 57. Further, the first bottom surfaces 565a slope downward while extending away from the position at which the insertion opening 566 is projected vertically onto the bottom surface of the toner chamber 57 in directions along the rotational axis Y of the developing roller 59.

The second bottom surface 565b is formed continuously with a rear end of each first bottom surface 565a. The second bottom surface 565b is a sloped surface that slopes downward toward the rear. The second bottom surface 565b is positioned rearward of the position at which the insertion opening 566 is projected vertically onto the bottom surface of the toner chamber 57.

The second bottom surface 565b slopes downward while extending away from the position at which the insertion opening 566 is projected vertically onto the bottom surface of the toner chamber 57. Further, the second bottom surface 565b slopes downward toward the developing roller 59 from the position at which the insertion opening 566 is projected vertically onto the bottom surface of the toner chamber 57.

The third bottom surfaces 565c are formed continuously with the respective first bottom surfaces 565a to extend leftward and rightward therefrom. Specifically, the third bottom surface 565c on the left is connected to the first bottom surface 565a on the left to extend leftward therefrom, while the third bottom surface 565c on the right is connected to the first bottom surface 565a on the right to extend rightward therefrom. The third bottom surfaces 565c are sloped surfaces that slope downward toward the rear.

The fourth bottom surface 565d extends rearward from a rear end of the second bottom surface 565b and a rear end of each third bottom surface 565c. The projecting wall 565e protrudes into the toner chamber 57 from the fourth bottom surface 565d and extends in a direction parallel to the rotational axis Y of the developing roller 59. The agitators 571 and 572 are arranged inside the toner chamber 57 in areas near the fourth bottom surface 565d.

The toner chamber 57 is defined as a space enclosed by the left side wall 561, right side wall 562, top wall 563, front wall 564, and bottom wall 565 of the developing unit frame 56. The toner chamber 57 has a rear end that is open, and the developing roller 59 is disposed in the open rear end of the toner chamber 57.

The developing unit frame 56 is urged toward the rear in the second direction by an urging member (not illustrated). Through an urging force of the non-illustrated urging member, the developing unit frame 56 is movable in the second direction along the long axes of the first elongate holes 5211 and 5221 and the long axes of the second elongate holes 5212 and 5222. When the developing unit frame 56 moves in the second direction, the developing roller 59 moves toward the photosensitive drum 53 in the second direction. In other words, the urging member is a pressing member that presses the developing roller 59 toward the photosensitive drum 53 in the second direction. In this way, the developing unit 55 is attached to the drum unit 51 such that the developing unit 55 is movable in the second direction relative to the drum unit 51.

Since the developing roller 59 is movable in the second direction relative to the photosensitive drum 53 and the urging member is configured to press the developing roller 59 in the second direction toward the photosensitive drum 53, any outer diameter run-out in the developing roller 59 can be restrained, thereby ensuring that the developing roller 59 rotates smoothly.

### Seal Member

A seal member 80 is disposed in a gap between an inner circumferential surface of the insertion opening 566 in the developing unit frame 56 and the cylindrical portion 525a of the receptacle 525 in the drum frame 52. The seal member 80 is formed of an elastic member that can elastically deform, such as a sponge formed in an annular shape.

The seal member 80 has: an outer circumferential surface in contact with the inner circumferential surface defining the insertion opening 566 formed in the developing unit frame 56; and an inner circumferential surface in contact with an outer circumferential surface of the cylindrical portion 525a of the receptacle 525. As such, the seal member 80 seals the gap between the insertion opening 566 and the receptacle 525. The seal member 80 is an example of “seal member” of the disclosure.

Incidentally, the outer circumferential surface of the seal member 80 may be fixed to the inner circumferential surface of the insertion opening 566, or the inner circumferential surface of the seal member 80 may be fixed to the outer circumferential surface on the cylindrical portion 525a of the receptacle 525. Alternatively, both the outer circumferential surface of the seal member 80 may be fixed to the inner circumferential surface of the insertion opening 566 and the inner circumferential surface of the seal member 80 may be fixed to the outer circumferential surface on the cylindrical portion 525a of the receptacle 525.

By elastically deforming, the seal member 80 can tolerate relative movement between the insertion opening 566 and the receptacle 525. Therefore, the seal member 80 can maintain the sealing between the insertion opening 566 and the receptacle 525, even if the insertion opening 566 moves relative to the receptacle 525 as a result of the movement of the developing unit frame 56 relative to the drum frame 52.

### Unit-Side Shutter

As illustrated in FIGS. 4 and 10 through 12B, the process cartridge 50 has a unit-side shutter 81 that can open and close the supply port 525c in the receptacle 525. The unit-side shutter 81 is accommodated in the receptacle 525 of the drum unit 51. The unit-side shutter 81 has a cylindrical portion 811, a bottom portion 812, an opening 813, and an engaging protrusion 814. The engaging protrusion 814 is an example of “second receiving part” of the disclosure.

The cylindrical portion 811 is formed in a hollow cylindrical shape that is elongated in the up-down direction. The cylindrical portion 811 has an open top end. The bottom portion 812 is a plate-shaped member that closes a bottom end of the cylindrical portion 811.

The cylindrical portion 811 has an outer circumferential surface that opposes an inner circumferential surface of the cylindrical portion 525a of the receptacle 525. The bottom portion 812 of the unit-side shutter 81 has a bottom surface that opposes a top surface of the bottom portion 525b of the receptacle 525. An elongate hole 812a is formed in the bottom portion 812. The elongate hole 812a extends in a circumferential direction of the bottom portion 812. The anchoring pin 525d of the receptacle 525 is inserted in the elongate hole 812a from below.

The opening 813 is formed in the cylindrical portion 811. The engaging protrusion 814 protrudes radially inward from an inner circumferential surface of the cylindrical portion 811 and extends in the up-down direction. The engaging protrusion 814 is positioned at a top end portion of the cylindrical portion 811. The opening 813 and engaging protrusion 814 are at positions 90 degrees out of phase from each other in a circumferential direction of the cylindrical portion 811, for example.

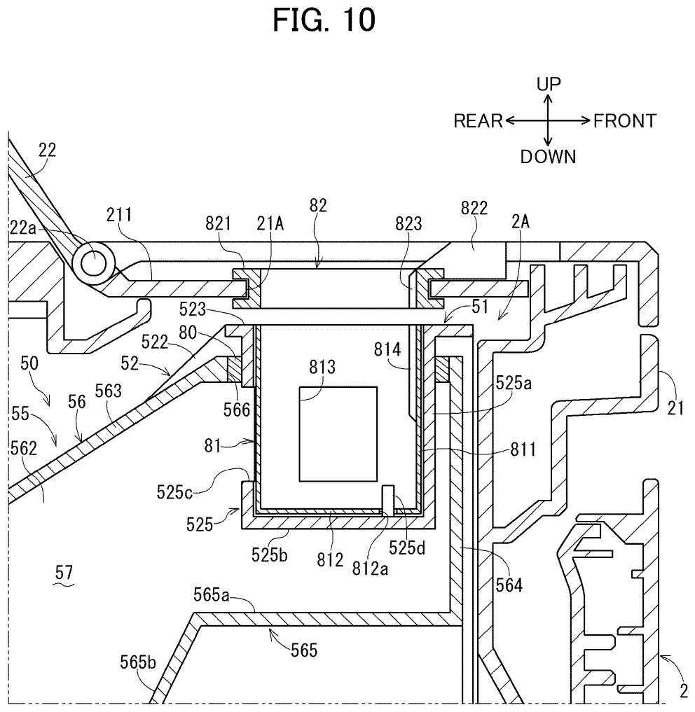

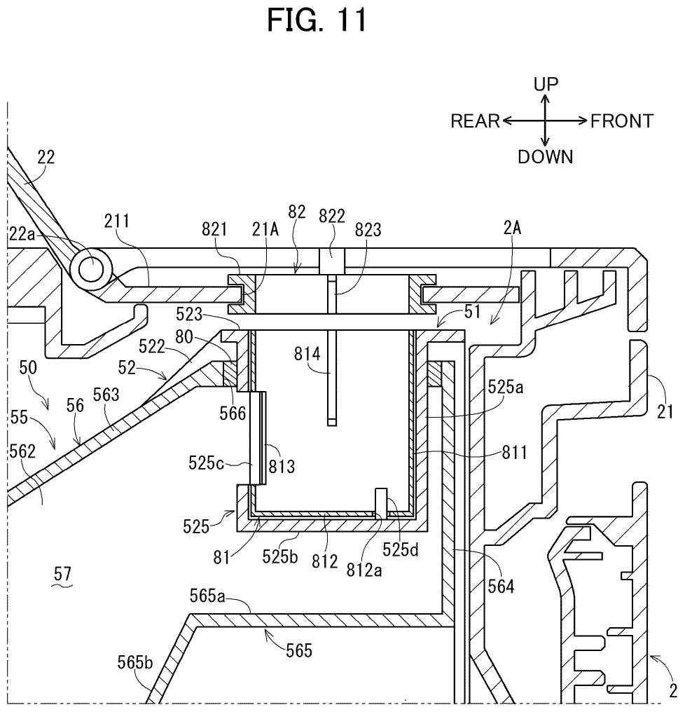

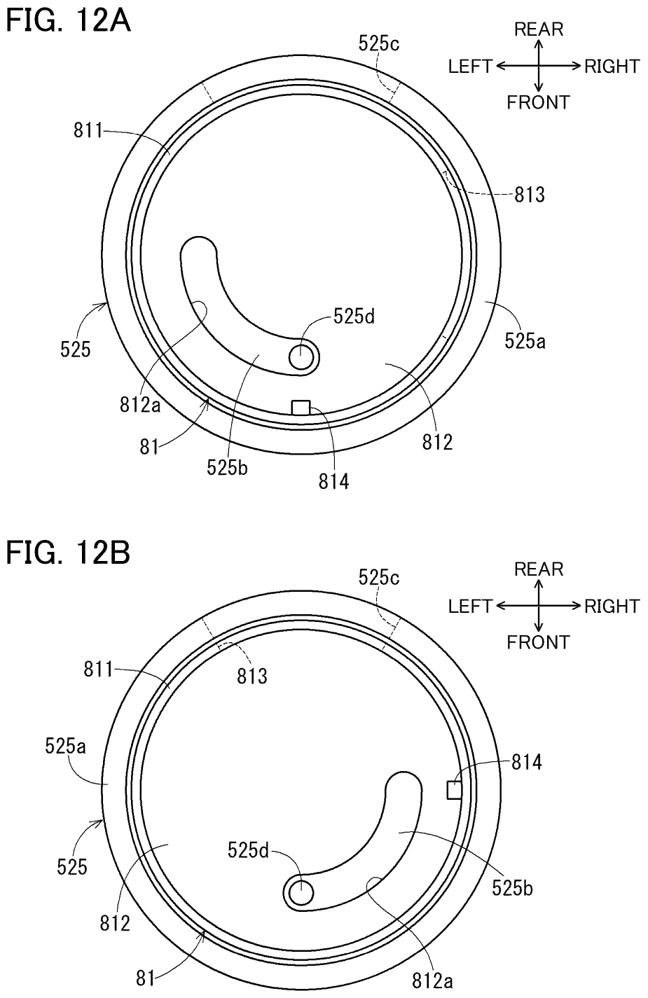

The unit-side shutter 81 is pivotable inside the receptacle 525 about a pivot axis aligned in the up-down direction. By pivoting about this pivot axis, the unit-side shutter 81 can move between a first shutter closed position (illustrated in FIGS. 10 and 12A) in which the opening 813 is on the right side, and a first shutter open position (illustrated in FIGS. 11 and 12B) in which the opening 813 is on the rear side.

When the unit-side shutter 81 is in the first shutter closed position, the supply port 525c of the receptacle 525 and the opening 813 of the unit-side shutter 81 are out of phase in the circumferential direction, and the supply port 525c is closed by the unit-side shutter 81.

When the unit-side shutter 81 is in the first shutter open position, the supply port 525c of the receptacle 525 and the opening 813 of the unit-side shutter 81 are in the same circumferential phase, and the supply port 525c is exposed by the unit-side shutter 81.

The engaging protrusion 814 is positioned on the front side when the unit-side shutter 81 is in the first shutter closed position, whereas the engaging protrusion 814 is on the right side when the unit-side shutter 81 is in the first shutter open position. The engaging protrusion 814 is movable between the front side and the right side in association with the movement of the unit-side shutter 81 between the first shutter closed position and first shutter open position.

The anchoring pin 525d of the receptacle 525 is movable relative to the unit-side shutter 81 inside the elongate hole 812a in the bottom portion 812. The anchoring pin 525d is configured to move within the elongate hole 812a as the unit-side shutter 81 is rotated.

When the unit-side shutter 81 is in the first shutter closed position, the anchoring pin 525d is at an upstream end of the elongate hole 812a in a clockwise direction when viewed from above (see FIG. 12A). When the unit-side shutter 81 is in the first shutter open position, the anchoring pin 525d is at a downstream end of the elongate hole 812a in the clockwise direction when viewed from above (see FIG. 12B).

### Front Cover and Refill Cover

As illustrated in FIGS. 1 through 4 and 13, the front cover 21 has an opening 21A. The opening 21A is formed in a top surface of the front cover 21 in the first closed position, and extends through the front cover 21 in the first closed position in the up-down direction. The opening 21A is formed in a stepped portion 211 of the top surface of the front cover 21, the stepped portion 211 being recessed further downward relative to a remaining portion of the top surface of the front cover 21 in the first closed position. The stepped portion 211 is formed in a rectangular shape. The opening 21A is circular in shape. The opening 21A is an example of “second opening” of the disclosure.

The main housing 2 further includes a refill cover 22. The refill cover 22 is disposed on the front cover 21 and is configured to open and close the opening 21A. The refill cover 22 is an example of “second cover” of the disclosure.

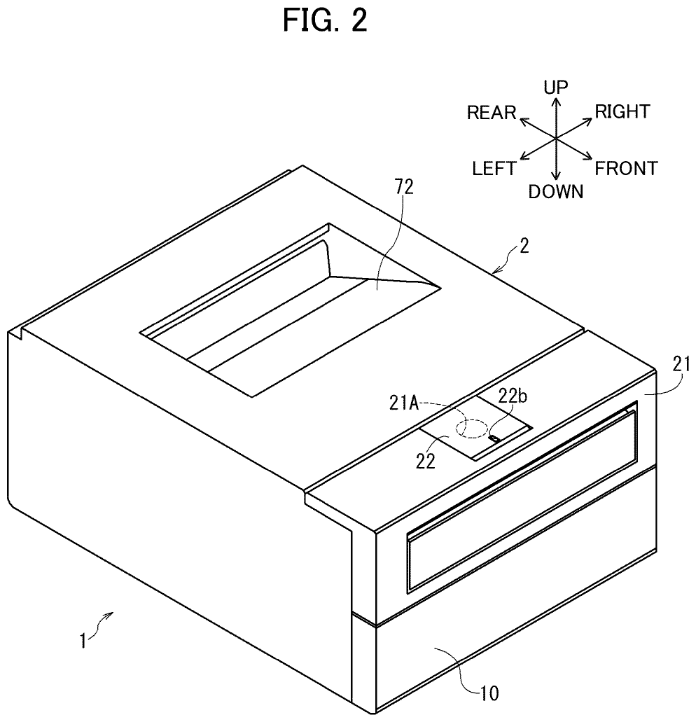

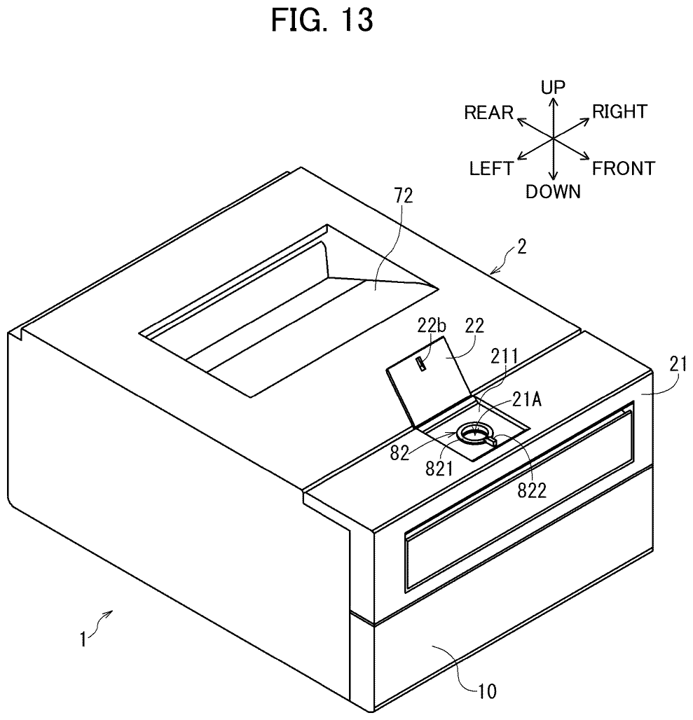

The refill cover 22 is movable between a second closed position (illustrated in FIG. 2) for closing the opening 21A and a second open position (illustrated in FIG. 13) for exposing the opening 21A. The refill cover 22 is formed in a rectangular shape corresponding to the shape of the stepped portion 211. When in the second closed position, the refill cover 22 is seated in the stepped portion 211.

The refill cover 22 is movable between the second closed position and the second open position by pivoting about an axis of a pivot shaft 22a. The pivot shaft 22a is located on a rear end portion of the refill cover 22 and extends in the left-right direction. The refill cover 22 is positioned farther rearward in the second open position than in the second closed position. That is, the refill cover 22 is positioned closer to a rear end portion of the main housing 2 in the front-rear direction at the second open position than at the second closed position. The rear end portion of the main housing 2 is an example of “second end portion” of the main housing of the disclosure.

When the front cover 21 is in the first closed position, the receptacle 525 of the drum unit 51 is positioned beneath the opening 21A in the front cover 21 and the opening 21A is in communication with the receptacle 525. When the front cover 21 is in the first closed position and the refill cover 22 is in the second open position, the receptacle 525 is exposed outside the main housing 2 through the opening 21A (see FIGS. 4 and 13). Hence, by moving the refill cover 22 to the second open position, the toner container 90 can be easily mounted on and removed from the receptacle 525 through the opening 21A.

Further, when the front cover 21 is in the first closed position and the refill cover 22 is in the second closed position, the refill cover 22 covers the receptacle 525 and the opening 21A from above (see FIGS. 1 and 2). In this way, moving the refill cover 22 to the second closed position can restrict dusts or other foreign matters from entering the receptacle 525.

### Operating Member

As illustrated in FIGS. 4, 10, 11, and 13, the front cover 21 includes an operating member 82. The operating member 82 is an example of “operating member” of the disclosure.

The operating member 82 includes a ring-shaped member 821, an operating lever 822, and an engaging protrusion 823. The engaging protrusion 823 is an example of “first engaging part” of the disclosure.

The ring-shaped member 821 has an annular shape. The ring-shaped member 821 is rotatably disposed over a periphery of the opening 21A in the front cover 21. The operating lever 822 extends radially outward from the ring-shaped member 821. The operating lever 822 is located within the stepped portion 211 of the front cover 21.

The operating member 82 can be rotated by user's gripping the operating lever 822 with his fingers and moving the operating lever 822 in a circumferential direction of the operating member 82. The engaging protrusion 823 protrudes radially inwardly from an inner circumferential surface of the ring-shaped member 821 and extends in the up-down direction.

The operating lever 822 and engaging protrusion 823 are arranged at the same phase in the circumferential direction, for example. In FIGS. 4, 10, and 13, the operating lever 822 and engaging protrusion 823 are located on the front side of the operating member 82. In FIG. 11, the operating lever 822 and engaging protrusion 823 are positioned on the right side of the operating member 82.

The operating member 82 is in a first position when the operating lever 822 and engaging protrusion 823 are on the front side and in a second position when the operating lever 822 and engaging protrusion 823 are on the right side. The operating member 82 is pivotable between the first position and the second position. The engaging protrusion 823 is configured to move between the front side and the right side in association with the pivoting of the operating member 82 between the first position and the second position.

### Toner Container

As illustrated in FIGS. 14 and 15, the toner container 90 for replenishing the process cartridge 50 with toner includes a container body 91 that stores toner, a discharging part 92, and a container-side shutter 93 disposed on the discharging part 92. The discharging part 92 is connectable to the receptacle 525 of the process cartridge 50.

The discharging part 92 has a hollow cylindrical shape and extends downward from a bottom end of the container body 91. The discharging part 92 has an inlet port 921, an outlet port 922, an outlet channel 923, and a pin groove 924. The inlet port 921 is open in a top surface of the discharging part 92. The outlet port 922 is open in an outer circumferential surface of the discharging part 92 on the rear side thereof. The outlet channel 923 connects the inlet port 921 to the outlet port 922. The pin groove 924 is formed in a bottom endface of the discharging part 92.

The toner stored in the container body 91 can flow into the discharging part 92 through the inlet port 921, and then be discharged out of the toner container 90 through the outlet port 922 after flowing through the outlet channel 923.

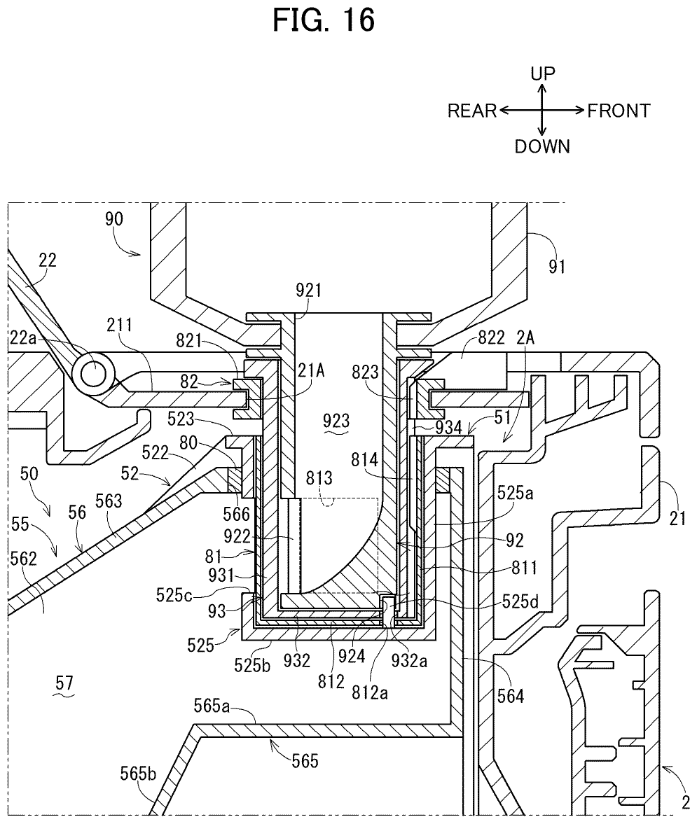

The discharging part 92 can be inserted into the opening 21A of the front cover 21. After passing through the opening 21A from above, the discharging part 92 can be further inserted into the receptacle 525 of the process cartridge 50. By inserting the discharging part 92 into the receptacle 525, the discharging part 92 and receptacle 525 are connected to each other. In a state where the discharging part 92 is connected to the receptacle 525, the anchoring pin 525d of the receptacle 525 is inserted in the pin groove 924 formed in the discharging part 92 (see FIG. 16). The pin groove 924 is an example of “third receiving part” of the disclosure.

Since the anchoring pin 525d is inserted in the pin groove 924 while the discharging part 92 is connected to the receptacle 525, the anchoring pin 525d engages the pin groove 924, thereby restricting any attempt to rotate the discharging part 92 about an axis thereof aligned in the up-down direction. In the state where the discharging part 92 is connected to the receptacle 525, the supply port 525c of the receptacle 525 and the outlet port 922 of the discharging part 92 are in phase in the circumferential direction.

The container-side shutter 93 is arranged to cover the discharging part 92 from outside thereof. The container-side shutter 93 has a cylindrical portion 931, a bottom portion 932, an opening 933, and an engaging groove 934. The engaging groove 934 is an example of “first receiving part” of the disclosure. The engaging groove 934 is also an example of “second engaging part” of the disclosure.

The cylindrical portion 931 has a hollow cylindrical shape that is elongated in the up-down direction. The cylindrical portion 931 has an open top end. The bottom portion 932 is a plate-shaped member that closes a bottom end of the cylindrical portion 931. The discharging part 92 is inserted in the container-side shutter 93 from the open top end of the cylindrical portion 931, at which time the cylindrical portion 931 covers an outer circumferential surface of the discharging part 92 and the bottom portion 932 covers the bottom endface of the discharging part 92.

The cylindrical portion 931 has an inner circumferential surface that opposes the outer circumferential surface of the discharging part 92. The top surface of the bottom portion 932 opposes the bottom endface of the discharging part 92. An elongate hole 932a is formed in the bottom portion 932. The elongate hole 932a extends in a circumferential direction of the bottom portion 932. The anchoring pin 525d of the receptacle 525 can be inserted into the elongate hole 932a from below.

The opening 933 is formed in the cylindrical portion 931. The engaging groove 934 is a groove that extends in the up-down direction and that is recessed radially inward from an outer circumferential surface of the cylindrical portion 931. The engaging groove 934 extends from the top end to the bottom end of the cylindrical portion 931. The opening 933 and engaging groove 934 are arranged to be 90 degrees out of phase in a circumferential direction of the cylindrical portion 931, for example.

The container-side shutter 93 can pivot about a pivot axis thereof aligned in the up-down direction. By pivoting the container-side shutter 93 about this pivot axis, the container-side shutter 93 is movable between a second shutter closed position (illustrated in FIG. 14) in which the opening 933 is on the right side, and a second shutter open position (illustrated in FIG. 15) in which the opening 933 is on the rear side.

When the container-side shutter 93 is in the second shutter closed position, the outlet port 922 of the discharging part 92 and the opening 933 of the container-side shutter 93 are out of phase in the circumferential direction so that the container-side shutter 93 covers the outlet port 922.

When the container-side shutter 93 is in the second shutter open position, the outlet port 922 of the discharging part 92 and the opening 933 of the container-side shutter 93 are in phase in the circumferential direction so that the container-side shutter 93 exposes the outlet port 922.

The engaging groove 934 is located on the front side when the container-side shutter 93 is in the second shutter closed position and on the right side when the container-side shutter 93 is in the second shutter open position. The engaging groove 934 is configured to move between the front side and the right side in association with the movement of the container-side shutter 93 between the second shutter closed position and second shutter open position.

The anchoring pin 525d of the receptacle 525 is configured to move within the elongate hole 932a of the bottom portion 932 as the container-side shutter 93 is pivoted, so that the anchoring pin 525d can move relative to the bottom portion 932 of the container-side shutter 93.

When the container-side shutter 93 is in the second shutter closed position, the anchoring pin 525d is at a downstream end of the elongate hole 932a in the clockwise direction when viewed from below (see FIG. 14B). When the container-side shutter 93 is in the second shutter open position, the anchoring pin 525d is at an upstream end of the elongate hole 932a in the clockwise direction when viewed from below (see FIG. 15B).

### Replenishing the Process Cartridge With Toner From the Toner Container

As illustrated in FIG. 4, the receptacle 525 of the drum unit 51 can be exposed to the outside of the main housing 2 by moving the refill cover 22 to the second open position while the front cover 21 is in the first closed position. With the receptacle 525 exposed to the outside, the discharging part 92 of the toner container 90 can be connected to the receptacle 525.

To connect the discharging part 92 of the toner container 90 to the receptacle 525, the discharging part 92 of the toner container 90 is inserted into the receptacle 525 while the container-side shutter 93 is in the second shutter closed position. At the same time, the unit-side shutter 81 is placed in the first shutter closed position and the operating member 82 is rotated to be placed in the first position.

When the discharging part 92 of the toner container 90 is inserted in the receptacle 525, as illustrated in FIG. 16, the engaging groove 934 of the container-side shutter 93 is in phase in the circumferential direction with the engaging protrusion 823 of the operating member 82 and the engaging protrusion 814 of the unit-side shutter 81. Accordingly, the engaging groove 934 is engaged with both the engaging protrusion 823 and the engaging protrusion 814. In this case, the portion of the engaging groove 934 engaged with the engaging protrusion 823 serves as the first receiving part of the disclosure, while the portion of the engaging groove 934 engaged with the engaging protrusion 814 serves as the second engaging part of the disclosure. In other words, in the present embodiment, the first receiving part and second engaging part of the disclosure are integral with each other to constitute a single part and are disposed on the container-side shutter 93.

Although the engaging protrusion 823 and engaging protrusion 814 are engaged in the same engaging groove 934 in this embodiment, the engaging protrusion 823 and engaging protrusion 814 may be configured to engage in different engaging grooves from each other. In this case, the engaging groove engaged with the engaging protrusion 823 and the engaging groove engaged with the engaging protrusion 814 are formed so as to operate in association with each other.

When the discharging part 92 of the toner container 90 is inserted into the receptacle 525, the anchoring pin 525d of the receptacle 525 is inserted into the elongate hole 812a of the unit-side shutter 81 and the elongate hole 932a of the container-side shutter 93. The anchoring pin 525d is further inserted into the pin groove 924 of the discharging part 92, thereby connecting the discharging part 92 of the toner container 90 to the receptacle 525.

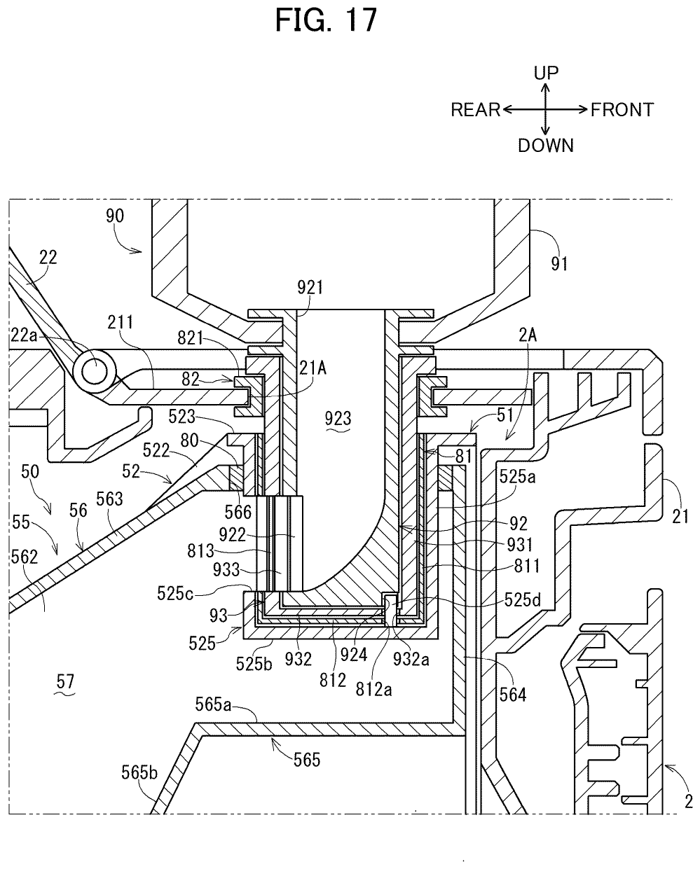

When the operating lever 822 is operated to rotate the operating member 82 from the first position to the second position while the discharging part 92 of the toner container 90 is connected to the receptacle 525, as illustrated in FIG. 17, the container-side shutter 93 moves from the second shutter closed position to the second shutter open position in association with the rotation of the operating member 82 since the engaging protrusion 823 of the operating member 82 is engaged with the engaging groove 934 of the container-side shutter 93.

Further, since the engaging protrusion 814 of the unit-side shutter 81 is engaged with the engaging groove 934 of the container-side shutter 93, the unit-side shutter 81 moves from the first shutter closed position to the first shutter open position in association with the movement of the container-side shutter 93 from the second shutter closed position to the second shutter open position.

In other words, the container-side shutter 93 is opened by rotating the operating member 82 from the first position to the second position while the engaging protrusion 823 of the operating member 82 is engaged with the engaging groove 934 of the container-side shutter 93. Further, the container-side shutter 93 and the unit-side shutter 81 are simultaneously opened by the operation of the operating member 82.

Since rotation of the discharging part 92 is restricted by the engagement of the anchoring pin 525d of the receptacle 525 in the pin groove 924 of the discharging part 92 at this time, the discharging part 92 is restricted from rotating together with the container-side shutter 93 as the container-side shutter 93 moves from the second shutter closed position to the second shutter open position.

When the container-side shutter 93 is moved to the second shutter open position, the opening 933 in the container-side shutter 93 is moved into phase with the outlet port 922 of the discharging part 92, whereby the container-side shutter 93 opens the outlet port 922 of the discharging part 92. When the unit-side shutter 81 is moved to the first shutter open position, the opening 813 in the unit-side shutter 81 is moved into phase with the supply port 525c in the receptacle 525, whereby the unit-side shutter 81 opens the supply port 525c of the receptacle 525.

Through this operation, the outlet port 922 of the discharging part 92 and the supply port 525c of the receptacle 525 are in communication with the toner chamber 57 of the developing unit 55, allowing the toner stored in the container body 91 to be supplied into the toner chamber 57 through the outlet port 922 and the supply port 525c.

After the toner chamber 57 has been completely replenished with the toner from the toner container 90, the operating lever 822 is operated to rotate the operating member 82 from the second position back to the first position. When the operating member 82 is rotated from the second position to the first position, the container-side shutter 93 moves from the second shutter open position to the second shutter closed position in association with the rotation of the operating member 82. The unit-side shutter 81 also moves from the first shutter open position to the first shutter closed position in association with the container-side shutter 93 moving from the second shutter open position to the second shutter closed position.

Through this operation, the container-side shutter 93 closes the outlet port 922 in the discharging part 92 and the unit-side shutter 81 closes the supply port 525c in the receptacle 525.

In other words, the container-side shutter 93 is closed by rotating the operating member 82 from the second position to the first position while the engaging protrusion 823 of the operating member 82 is engaged with the engaging groove 934 of the container-side shutter 93. Thus, the container-side shutter 93 and the unit-side shutter 81 are simultaneously closed by user's operating the operating member 82.

After the operating member 82 is rotated from the second position to the first position to close the outlet port 922 in the discharging part 92 and the supply port 525c in the receptacle 525, the discharging part 92 of the toner container 90 is removed from the receptacle 525.

After the discharging part 92 of the toner container 90 has been removed from the receptacle 525, the refill cover 22 is moved back to the second closed position to close the opening 21A. By closing the opening 21A with the refill cover 22 so that the receptacle 525 is covered from above by the refill cover 22, dusts and other foreign matters can be restrained from entering the receptacle 525 through the opening 21A while the toner container 90 is not connected to the receptacle 525.

In this way, the operating member 82 is configured to operate the container-side shutter 93 disposed around the discharging part 92 for opening and closing the outlet port 922 in the discharging part 92 in the state where the discharging part 92 of the toner container 90 is connected to the receptacle 525.

Therefore, when the toner container 90 is connected to the receptacle 525, the container-side shutter 93 of the toner container 90 can be easily opened and closed with the operating member 82. Further, since the operating member 82 is disposed on the front cover 21 and moves together with the front cover 21 as the front cover 21 is opened and closed, the operating member 82 will not interfere with operations for mounting and removing the process cartridge 50 in and from the main housing 2 through the opening 2A. Thus, this configuration can facilitate the operations for mounting the process cartridge 50 in and removing the process cartridge 50 from the main housing 2.

In the image-forming apparatus 1 according to the embodiment, the container-side shutter 93 is configured to be opened and closed by rotating the operating member 82 while the engaging protrusion 823 of the operating member 82 is engaged in the engaging groove 934 of the container-side shutter 93. Hence, the container-side shutter 93 can be easily opened and closed simply by operating the operating lever 822 to rotate the operating member 82.

The operating member 82 is configured to simultaneously open and close the container-side shutter 93 and the unit-side shutter 81. Hence, the container-side shutter 93 and the unit-side shutter 81 can be opened and closed simultaneously by operating the operating member 82, thereby simplifying the opening and closing operations.

The container-side shutter 93 of the toner container 90 has the engaging groove 934 engageable with the engaging protrusion 823 of the operating member 82, and the process cartridge 50 has the engaging protrusion 814 engageable with the engaging groove 934 and movable in association with the unit-side shutter 81. Accordingly, the container-side shutter 93 and the unit-side shutter 81 can be simultaneously opened and closed simply by rotating the operating member 82.

Since the engaging groove 934 is disposed in the container-side shutter 93 and the engaging protrusion 814 is disposed on the unit-side shutter 81, the configurations of the discharging part 92 in the toner container 90 and the receptacle 525 in the process cartridge 50 can be simplified.

The anchoring pin 525d of the receptacle 525 is engaged in the pin groove 924 of the discharging part 92 in the state where the discharging part 92 of the toner container 90 is connected to the receptacle 525. This engagement restricts the discharging part 92 of the toner container 90 from rotating together with the operating member 82, which would result in the container-side shutter 93 being unable to open and close when the operating member 82 is rotated.

In the image-forming apparatus 1 of the above embodiment, when the process cartridge 50 is mounted in the main housing 2, the drum unit 51 is fixed in position relative to the main housing 2 while the developing unit 55 can move relative to the drum unit 51. The receptacle 525 is disposed on the drum unit 51.

Accordingly, when the toner container 90 is connected to the receptacle 525 of the process cartridge 50 while the process cartridge 50 is mounted in the main housing 2, the toner container 90 can be easily connected to the process cartridge 50 even though the developing unit 55 is configured to be movable relative to the drum unit 51.

The seal member 80 is interposed between the insertion opening 566 of the developing unit 55 and the receptacle 525 of the drum unit 51 inserted in the insertion opening 566. Therefore, the toner from the toner container 90 can be smoothly supplied into the toner chamber 57 of the developing unit 55 while tolerating movement of the developing unit 55 relative to the drum unit 51.

### Relationship Between Operating Member and Refill Cover

As illustrated in FIG. 16, the engaging protrusion 823 of the operating member 82 and the engaging protrusion 814 of the unit-side shutter 81 are both positioned on the front side while the operating member 82 has been rotated to the first position and, thus, are in phase in the circumferential direction.

In this state, both the engaging protrusion 823 and the engaging protrusion 814 can be engaged in the engaging groove 934 of the container-side shutter 93 when the discharging part 92 of the toner container 90 is inserted into the receptacle 525 through the opening 21A. In other words, the first position of the operating member 82 is such a position at which the discharging part 92 of the toner container 90 can be connected to the receptacle 525 of the process cartridge 50.

Further, if the operating member 82 is to be rotated from the first position to the second position in a state where the discharging part 92 of the toner container 90 is not inserted in the receptacle 525, the engaging protrusion 823 of the operating member 82 is to move from the front side to the right side. However, since the engaging protrusion 823 of the operating member 82 is separated from the engaging protrusion 814 of the unit-side shutter 81, the engaging protrusion 814 of the unit-side shutter 81 remains in its position on the front side. That is, the phase of the engaging protrusion 823 on the operating member 82 is to be offset from the phase of the engaging protrusion 814 on the unit-side shutter 81.

Thus, if the discharging part 92 of the toner container 90 is attempted to be inserted into the receptacle 525 in a state where the operating member 82 is in the second position, the engaging groove 934 and the engaging protrusion 823 are to be engaged with each other by aligning the phases for the engaging groove 934 of the container-side shutter 93 and the engaging protrusion 823 of the operating member 82.

However, since the phase of the engaging protrusion 823 on the operating member 82 in this case is offset from the phase of the engaging protrusion 814 on the unit-side shutter 81, the engaging groove 934 of the container-side shutter 93 cannot be further engaged with the engaging protrusion 814 of the unit-side shutter 81 and, hence, the discharging part 92 cannot be inserted all the way into the receptacle 525. In other words, the second position of the operating member 82 is such a position that the discharging part 92 of the toner container 90 cannot be connected to the receptacle 525 of the process cartridge 50.

As illustrated in FIGS. 1, 4, and 13, the refill cover 22 has a groove 22b. The groove 22b is recessed upward from the bottom surface of the refill cover 22 when the refill cover 22 is in the second closed position. In this embodiment, the groove 22b extends through the refill cover 22 in the up-down direction when the refill cover 22 is in the second closed position. However, the groove 22b need not extend through the refill cover 22 entirely but may be closed on the top side.

The groove 22b is formed at a position and in a shape for fitting over the operating lever 822 of the operating member 82 when the operating member 82 is in the first position and the refill cover 22 is in the second closed position. The groove 22b cannot be fitted over the operating lever 822 while the operating member 82 is in the second position or any other position deviating from the first position.

Hence, when the refill cover 22 is moved from the second open position toward the second closed position while the operating member 82 is in the first position, the operating lever 822 is fitted into the groove 22b, enabling the refill cover 22 to move into the second closed position. When moved into the second closed position, the refill cover 22 is seated in the stepped portion 211 of the front cover 21.

On the other hand, if the refill cover 22 is moved from the second open position toward the second closed position while the operating member 82 is in the second position or any position deviating from the first position, the operating lever 822 contacts the bottom surface of the refill cover 22 rather than being fitted into the groove 22b, restricting the refill cover 22 from moving all the way into the second closed position. In other words, when the operating member 82 is in the second position, the refill cover 22 cannot be closed completely and remains elevated above the stepped portion 211 of the front cover 21.

Thus, by checking whether the refill cover 22 has been moved completely into the second closed position when moving the refill cover 22 toward the second closed position, the user can easily determine whether the operating member 82 is in the first position where the discharging part 92 can be connected to the receptacle 525.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Variations of the First Engaging Part, First Receiving Part, Second Engaging Part, and Second Receiving Part

In the embodiment described above, the engaging protrusion 823 (as the first engaging part) is disposed on the operating member 82; the engaging protrusion 814 (as the second receiving part) is disposed on the unit-side shutter 81; and the engaging groove 934 (as the first receiving part and as the second engaging part) is disposed on the container-side shutter 93.

However, an engaging groove may be formed in the operating member 82 as the first engaging part; an engaging groove may be formed in the unit-side shutter 81 as the second receiving part; and an engaging protrusion may be formed on the container-side shutter 93 as the first receiving part engageable with the engaging groove of the operating member 82 and as the second engaging part (engageable with the engaging groove of the unit-side shutter 81).

Alternatively, an engaging protrusion may be formed on the operating member 82 as the first engaging part; an engaging groove may be formed in the unit-side shutter 81 as the second receiving part; an engaging groove may be formed in the container-side shutter 93 as the first receiving part engageable with the engaging protrusion (first engaging part) of the operating member 82; and an engaging protrusion may be formed in the container-side shutter 93 as the second engaging part engageable with the engaging groove (second receiving part) of the unit-side shutter 81.

Still alternatively, an engaging groove may be formed in the operating member 82 as the first engaging part; an engaging protrusion may be formed on the unit-side shutter 81 as the second receiving part; an engaging protrusion may be formed on the container-side shutter 93 as the first receiving part engageable with the engaging groove (first engaging part) of the operating member 82; and an engaging groove may be formed in the container-side shutter 93 as the second engaging part engageable with the engaging protrusion (second receiving part) of the unit-side shutter 81.

### Variations of the Third Engaging Part and the Third Receiving Part

In the embodiment described above, the anchoring pin 525d is formed on the receptacle 525 as the third engaging part, and the pin groove 924 is formed on the discharging part 92 of the toner container 90 as the third receiving part engageable with the anchoring pin 525d (third engaging part). However, an anchoring pin may be formed on the discharging part 92 as the third receiving part, and a pin groove may be formed in the receptacle 525 as the third engaging part engageable with the anchoring pin (third receiving part) on the discharging part 92.

What is claimed is:

1. An image-forming apparatus comprising:
a main housing having a first opening;
a process cartridge mountable in and removable from the main housing through the first opening, the process cartridge comprising:
a drum unit including a photosensitive drum;
a developing unit including a developing roller; and
a receptacle to which a toner container storing toner is connectable, the toner container including a discharging part connectable to the receptacle and a container-side shutter disposed on the discharging part for opening and closing the discharging part; and
a first cover movable relative to the main housing to open and close the first opening, the first cover having a second opening through which the receptacle can be exposed, the first cover including an operating member configured to move the container-side shutter to open and close the discharging part in a state where the discharging part of the toner container is connected to the receptacle.

2. The image-forming apparatus according to claim 1, further comprising a second cover disposed on the first cover and configured to open and close the second opening.

3. The image-forming apparatus according to claim 2,
wherein the main housing has a first end portion and a second end portion opposite the first end portion in a first direction, the receptacle being positioned closer to the first end portion of the main housing in the first direction than to the second end portion of the main housing in a state where the process cartridge is mounted in the main housing,
wherein the first cover is movable between a first closed position for closing the first opening and a first open position for exposing the first opening, the first cover being positioned farther away from the first end portion of the main housing in the first direction at the first open position than at the first closed position, and
wherein the second cover is movable relative to the first cover between a second closed position for closing the second opening and a second open position for exposing the second opening, the second cover being positioned closer to the second end portion of the main housing in the first direction at the second open position than at the second closed position.

4. The image-forming apparatus according to claim 2,
wherein the operating member is rotatable between a first position and a second position relative to the first cover, the operating member at the first position enabling the discharging part of the toner container to be connected to the receptacle, the operating member at the second position restricting the discharging part of the toner container from being connected to the receptacle,
wherein the second cover has a groove, and
wherein the operating member is fitted in the groove at the first position, and the operating member is not fitted in the groove at the second position.

5. The image-forming apparatus according to claim 1,
wherein the operating member comprises:
a ring-shaped member fitted over a periphery of the second opening on the first cover, the ring-shaped member being rotatable relative to the second opening;
an operating lever extending radially outwardly from the ring-shaped member; and
a first engaging part disposed on an inner circumferential surface of the ring-shaped member, the first engaging part being engageable with a first receiving part of the toner container, the first receiving part being movable in association with movement of the container-side shutter, and
wherein rotation of the operating member opens and closes the container-side shutter in a state where the first engaging part is engaged with the first receiving part.

6. The image-forming apparatus according to claim 5,
wherein the process cartridge further includes a unit-side shutter configured to open and close the receptacle, and
wherein the operating member is configured to open and close both the container-side shutter and the unit-side shutter simultaneously.

7. The image-forming apparatus according to claim 6,
wherein the toner container further includes a second engaging part movable in association with movement of the first receiving part, and
wherein the process cartridge further includes a second receiving part engageable with the second engaging part, the second receiving part being movable in association with movement of the unit-side shutter.

8. The image-forming apparatus according to claim 7,
wherein the first receiving part and the second engaging part are disposed on the container-side shutter, and
wherein the second receiving part is disposed on the unit-side shutter.

9. The image-forming apparatus according to claim 8,
wherein the first receiving part and the second engaging part are integral with each other on the container-side shutter.

10. The image-forming apparatus according to claim 7,
wherein the process cartridge further includes a third engaging part engageable with a third receiving part of the toner container, and
wherein the third engaging part is engaged with the third receiving part in the state where the discharging part of the toner container is connected to the receptacle of the process cartridge.

11. The image-forming apparatus according to claim 1,
wherein, in a state where the process cartridge is mounted in the main housing, the drum unit is fixed in position relative to the main housing and the developing unit is movable relative to the drum unit, and
wherein the receptacle is disposed at the drum unit.

12. The image-forming apparatus according to claim 11,
wherein the developing unit includes a developing-unit frame having an insertion opening, and
wherein the receptacle is received in the developing unit attached to the drum unit through the insertion opening, a seal member being fitted in a gap between the receptacle and an inner circumferential surface of the insertion opening of the developing-unit frame.
